(19) United States
(12) Patent Application Publication
(10) Pub. No.: US 2014/0258234 A1
(43) Pub. Date: Sep. 11, 2014

(54) SYNCHRONIZATION OF CMS DATA TO MOBILE DEVICE STORAGE

(71) Applicant: AppGlu, Inc., (unknown)

(72) Inventors: Paulo H. Michels, Pleasant Hill, CA (US); Eric N. Shapiro, San Francisco, CA (US); Devin A. Poolman, San Francisco, CA (US)

(21) Appl. No.: 14/203,431

(22) Filed: Mar. 10, 2014

Related U.S. Application Data
(60) Provisional application No. 61/776,609, filed on Mar. 11, 2013.

(51) Int. Cl. G06F 17/30

(52) U.S. Cl. CPC G06F 17/30575; G06F 17/30309
USPC 707/638

(57) ABSTRACT

Aspects include systems and methods for synchronizing a remote datastore that includes files and data for use by an application on a remote device, which can be represented on the device in a device-specific format, while the remote data store can have a different data representation, such as a relational database or object graph data model. A server can maintain a unique row identifier for each row in all synchronized tables and an update log table that has rows with the unique row identifiers for changed rows (inserted, updated or deleted), for each insert, update, or delete operation and a current update version that reflects the last change to that row. An update request from a device can comprise identifiers for a (sub)set of the data. The update log table can be used to prepare an update package containing this data.

### CROSS REFERENCE TO RELATED APPLICATIONS

This application claims priority from U.S. Provisional Patent Application No. 61/776,609, entitled, “SYNCHRONIZATION OF CMS DATA TO MOBILE DEVICE STORAGE”, filed on Mar. 11, 2013, which is incorporated herein in its entirety for all purposes.

### BACKGROUND

1. Field

The following relates to portable devices (e.g., smart phones) that can install and run applications (apps) and in a more particular aspect, to managing and updating content and resource files used by applications installed on mobile devices.

2. Related Art

The usage model of installing an application on a portable device that locally executes the application and operates with a local data store has become a predominant usage model for small form factor mobile computing and increasingly, for content consumption.

### SUMMARY

As introduced above, an application that is installed on a mobile device is typically capable of accessing local data storage resident on the mobile device. Such local data store can be initially populated when the application is installed on the mobile device. Many users of mobile devices may initially identify, download and install a given application from a central application repository or store. In many cases, these application stores are sponsored by a maker of a particular mobile device or devices, a maker of software used with or in mobile devices (e.g., an operating system), or a provider of content that is consumed on mobile devices. These sources of applications can be viewed as application aggregators, in that they provide a mechanism for users to identify, pay for and download applications and potentially other content. The application aggregators can take a portion of the revenue obtained from each application, and may also have other monetization approaches, such as by selling advertising. These application aggregators can be useful to users of mobile devices because they provide a platform for application discovery and may also increase a level of trust by a user in a given application, since in some cases, the application aggregators may test applications or otherwise require an application to have certain characteristics or behavior in order to be available from the application aggregator. These rules and other processes can increase the difficulty of updating the data or resource files that are used in or with a given application.

In one aspect, a Content Management System (CMS) is provided which allows management of server-side data, and synchronization of a subset of that server-side data with local storage in a mobile device having the application installed. The CMS provides for a convenient mechanism to enter and maintain data that will be synchronized and additionally provides a synchronization approach that is appropriate for devices that may have comparatively limited data bandwidth (e.g., a cellular connection versus a WiFi connection), or which may incur data charges for downloading under certain conditions. The following disclosure presents a variety of details concerning implementations of such a CMS and related methods and systems.

By providing an approach to CMS for mobile device applications, which abstracts underlying maintenance of table data and resource files, content creators and business managers can have more direct and immediate control over content updates.

### BRIEF DESCRIPTION OF THE DRAWINGS

FIG. 1 depicts a situation where application and data updates may be made to a database, which are to be synchronized to local storage of mobile devices having the application installed;

FIG. 2 depicts high level aspects of a synchronization process according to the disclosure;

FIGS. 3A and 3B depict software and hardware aspects of an example implementation of relevant portions of a mobile device according to FIG. 1;

FIG. 4 depicts a process embodying disclosed aspects of data synchronization according to the disclosure;

FIG. 5A depicts a more specific example process undertaken to implement data synchronization according to the disclosure;

FIGS. 5B and 5C depicts portions of the example process of FIG. 5A;

FIGS. 6-15 depict data tables that are synchronized in the example of FIGS. 5A-5C and FIGS. 16A and 16B;

FIGS. 16A and 16B depict a synchronization process undertaken between a mobile device and a source of current data; and

FIGS. 17A and 17B depict aspects of a process that can be implemented on a device receiving synchronization information.

### DETAILED DESCRIPTION

Mobile computing has changed from a paradigm largely dominated by a mixture of full-featured large screen laptop computers, and special purpose mobile devices, into a situation where full-featured devices have smaller form factors than a laptop, but larger displays than a traditional cell phone, and which function as content delivery and application platforms. This class of devices thus has a larger screen than a traditional cell phone, faster network interfaces, as well as more memory and more processing power to enable content consumption and a more configurable application offering. Such devices can have a different User Interface (UI), application development, and application deployment mechanisms than the traditional approach to software distribution that dominated the era of personal computing.

For example, a user may populate a mobile device (e.g., a smart phone or tablet) with a variety of functionally specific applications from a variety of vendors or providers. Applications may be games, may present interactive catalogs, e.g., parts catalogs than can be used by salespeople, allow restaurant reservations and reviews, or may deliver content, such as television programming, music, video, social networking, and so on. A mobile device (e.g., a smart phone) runs an operating system environment and typically includes tools to help software developers, such as a software development kit that has libraries of functions that can be used to implement applications.

One challenge to application updating and maintenance is that people who generate content that may be used in applications are not database developers or do not otherwise possess the skills or desire to engage in database maintenance. Therefore, an approach that abstracts database complexity and automates activities undertaken for database updating can help drive down costs of supporting these kinds of applications and improve the experience of business personnel that are involved with application content creation and updating. The following examples primarily use terminology appropriate for a relational database model, which uses the terms table, row and column, to refer to a collection of documents, where each may have a number of fields. This usage is for simplicity and such usage does not exclude other ways to represent or store such data. For example, another implementation may use a NoSQL database in which collections may correspond to tables, documents to rows, and fields to columns. Where disclosures herein refer to tables, rows and columns, these disclosures equally refer to equivalent representations of such data. As such, these disclosures are to be understood as applying to and referring to other data models which include an organizational approach in which collections of items can be formed, where those items each can have a set of elements.

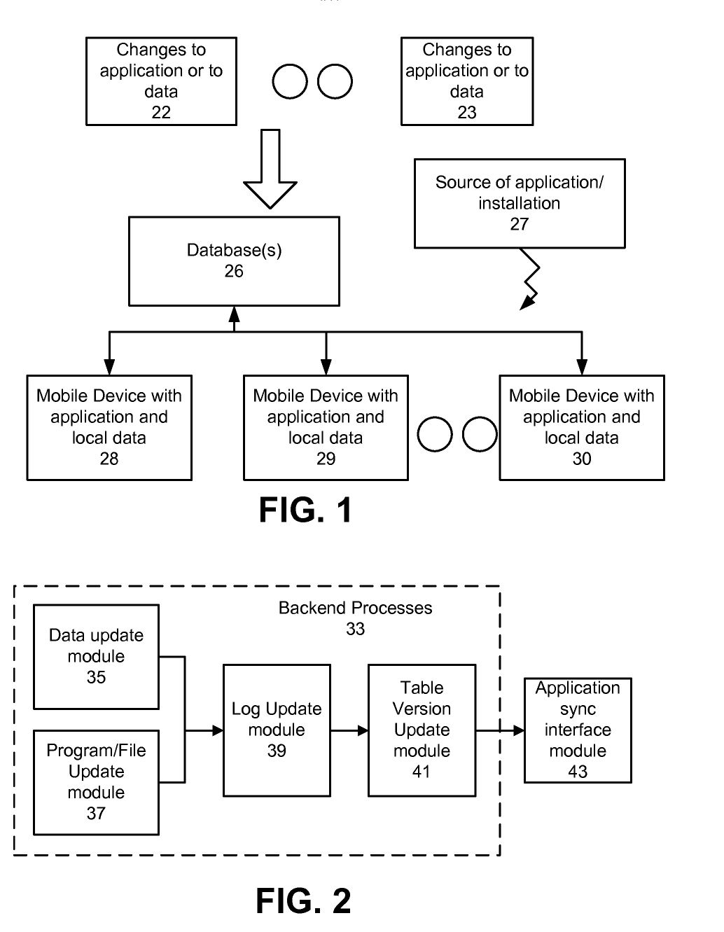

FIG. 1 depicts that changes 22-23 to application resource files or to application data can be generated and received at databases 26. Database(s) 26 can be structured as a set of tables, where each table has one or more rows (typically a plurality of rows). Each table has a defined set of data categories that can be populated for each row (referred to as columns). For example, a table with addresses for different people can have a column for city, state, and zip code, where a respective row is populated with the individual city state and zip code for each person. Database(s) 26 are shown as communicating with a plurality of mobile devices 28-30 that have installed an application, and a set of local data for use by the application. A source 27 of the application, which can serve as the initial installation source for the application, is shown. Source 27, can be, for example, a social media website, an application aggregator application or website, and so on. Thus, in FIG. 1, after an application is installed on mobile devices 28-30, data that changes in database(s) 26 as a result of changes 22-23, it is desirable to synchronize database(s) 26 (or some portion thereof) with local data on mobile devices 28-30, but it is undesirable to have to involve the original source of the application (27) in that synchronization.

FIG. 2 depicts aspects of backend processes 33 that are performed by or for database(s) in order to implement aspects of synchronization disclosed here. FIG. 2 depicts a data update process module 35 and a program/resource file update module 37 that intake changes to data and to application files (e.g., changes 22-23) and effect those changes on the underlying data or resource affected by the change. These modules 35 and 37 feed a log update module 39 that extracts information relating to changes to files or data that is synchronized with local data on mobile devices 28-30. A table version update module 41 implements a process that generates or maintains a table that tracks changes that ultimately will be synchronized with local data on mobile devices. An application sync interface module 43 interacts with mobile devices 28-30, in order to follow an implementation of the synchronization disclosures below.

In these examples, a module according to FIG. 2 can be implemented using programmable hardware, such as a programmable microprocessor that is configured with instructions obtained from medium. The medium can be non-transitory. Fixed function or special purpose hardware also can be provided to implement certain functions, such as digital signal processing, network interface functions, encryption processes and so on.

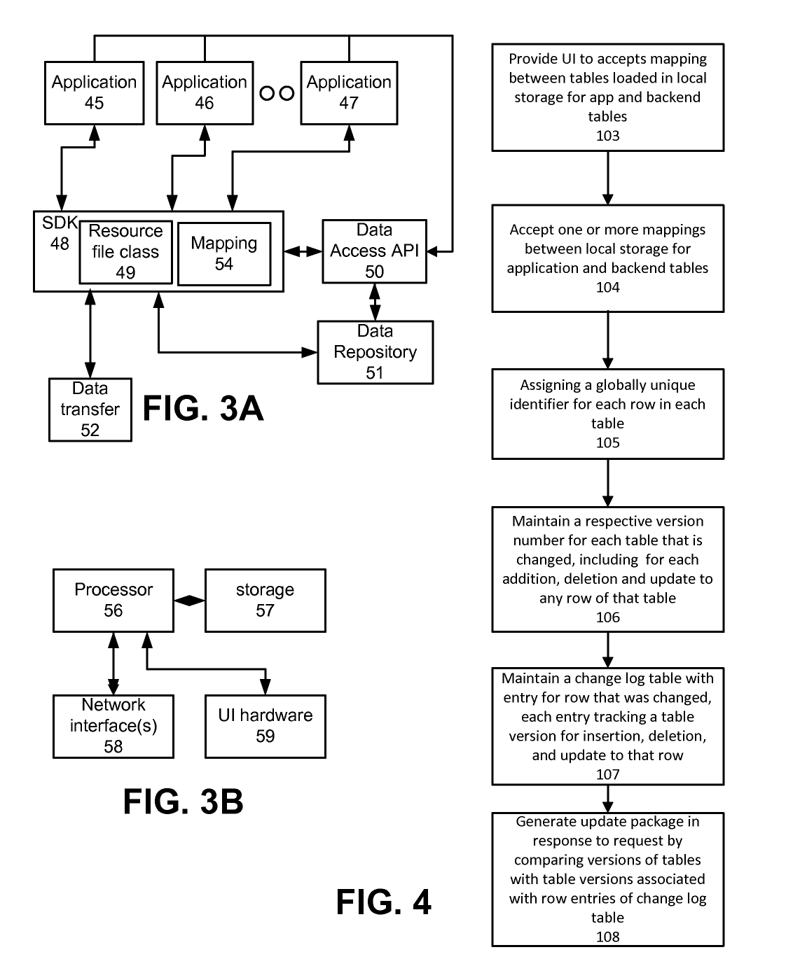

FIG. 3A depicts functional aspects of a mobile device (e.g., mobile devices 28-30), which can have installed thereon a plurality of applications 45-47. Each of these applications is programmed to use resources from a Software Development Kit (48), which includes a resource file class 49 that can be used by applications 45-48 to access resource files. A data access API 50 also can be provided. Data access API 50 can vary with the kind of mobile device, and can include a SQL interface, or a proprietary platform information access model, such as the “Core Data” access model of Apple™ operating systems. The SDK 48 and data access API 50 can interface with a data repository 51. A network interface 52 can be a source of information, such as the synchronization update data described below. Such update data can be received by SDK 48, processed and then stored in data repository 51.

FIG. 3B depicts a hardware-oriented perspective of a device that can implement processes disclosed herein. FIG. 3B depicts a processor 56 which stores and retrieves data from storage 57 (e.g., non-volatile flash memory, a hard disk drive, a random access memory, and so on), and with one or more network interface(s) 58 (e.g., an LTE or GPRS or 3G data interface, or a WiFi module). UI hardware 59 also can be provided, which can vary depending on the type of usage. For example, a mobile device may have a touch screen and voice recognition, while a server may have a command line interface or a web-based management interface that is served from processor 56.

In some implementations, a person who is updating content in the Content Management System (CMS) can be presented with a UI that generally replicates the look and feel of the application itself and enter new data in fields presented in the application. The look and feel can be represented by a schema. In some implementations, when the schema is changed, that schema change may result in changes to one or more synchronized tables or files, and as will be described below, the schema may be represented by a set of resource files. For example, if a column is added to a table, that column may represent additional information that will be contained in a given schema that uses a set of tables. Data from that new column may be referenced in other tables in the schema.

FIG. 4 depicts activities that are undertaken to structure and to populate a database, and to produce data used in synchronization processes for local data on mobile devices. At 103, a UI is provided to accept mappings between tables that are loaded (or to be loaded) in mobile device local storage, and backend tables. The example of a UI to accept data to be stored in the data store, or a mapping between tables is not exclusive of any other source of data or mappings; for example data and mappings can be established programmatically.

At 104, through the UI, one or more mappings between such tables are accepted. At 105, a globally (within the tables being synchronized) unique identifier for each row in each table is made. The activity of 105 may be distributed in time, such that when a given row or data element is created, an identifier is assigned to that row. A global count or other incrementing field can be provided from which an identifier can be obtained and then incremented. At 106, and for each table (can be limited to tables to be synchronized), a version number is maintained. The version number is incremented whenever there is a change to that table, including addition of rows, deletion of rows, and an update to any existing row.

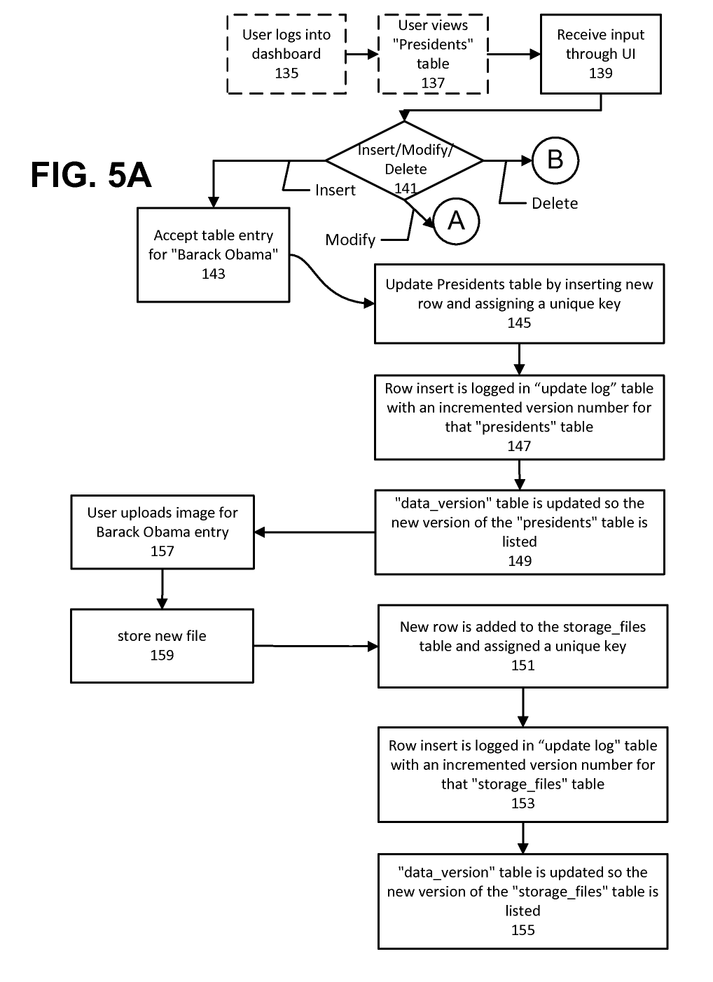

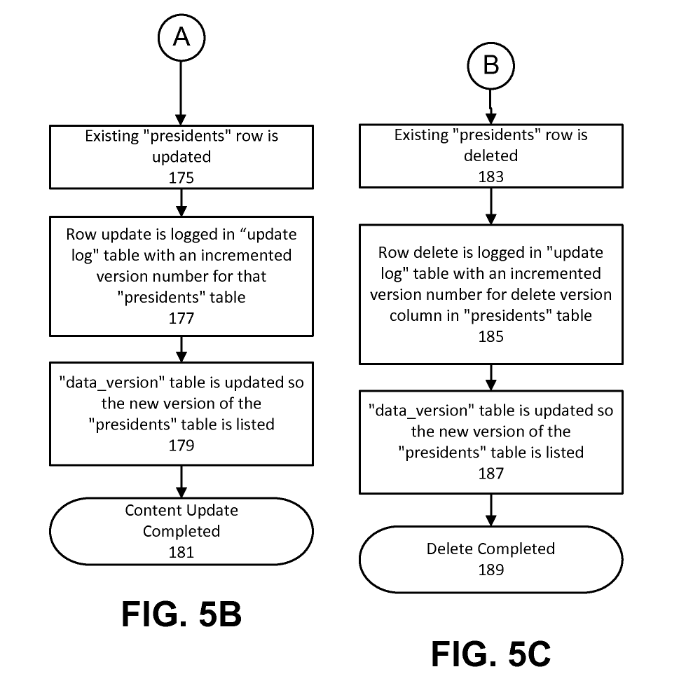

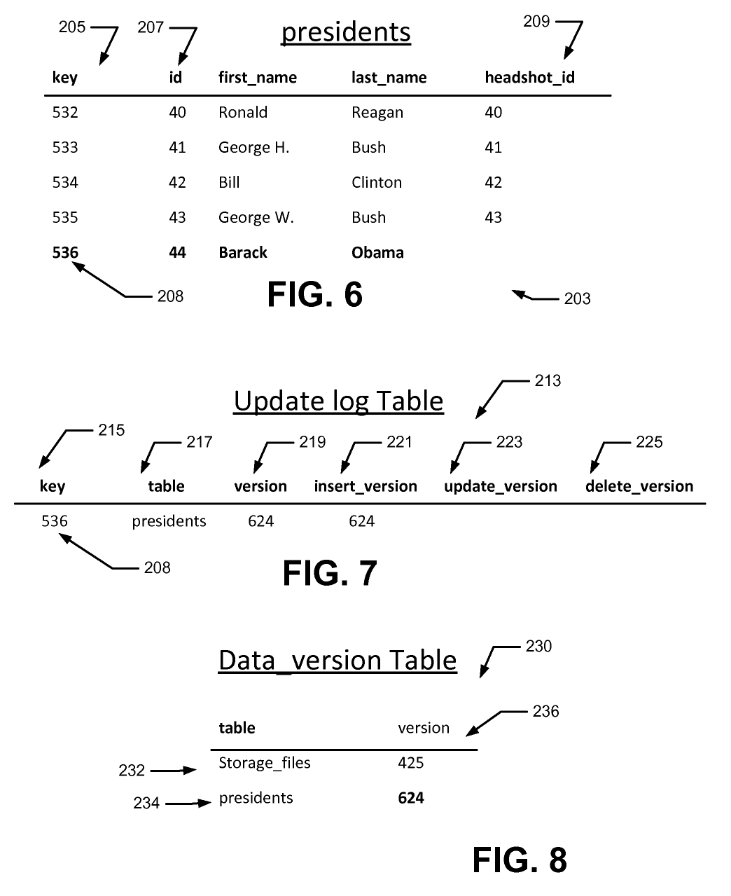

At 107, an update log table 213 (see FIG. 7) is maintained to include an entry for each row of any synchronized table, for which a change has been detected. In the update log table 213, each row entry (corresponds to a row of any synchronized table, and includes a current table version when that row entry was last inserted, updated, and deleted is maintained. At 108, based on the contents of the update log table 213, an update package can be generated in response to a request for synchronization from a mobile device. The request can include current versions for synchronized tables on the mobile device requesting the update. An example of how aspects of the process of FIG. 4 can be implemented is explained with reference to the remaining figures. FIG. 5A depicts a process of table updating in order maintain data used in preparing synchronization package to be sent to mobile devices. This example uses a presidents table 203 (FIG. 6) having a row for each of several recent U.S. presidents. Other tables used in the example, which are produced and maintained for synchronization purposes are an update log table 213 and a data version table 230. The primarily example described here relates to updating a set of tables (e.g., that entire tables are synchronized). However, other implementations may provide for synchronization of portions of tables, and portions of resources referenced by such tables. These implementations are described in more detail after the primary example.

In FIG. 5A, at 135, a user can log into a dashboard to update content (here, a dashboard refers to a UI that provides a set of forms or other guided approach to information entry or updating). At 137, the user views a “Presidents” table 203, depicted in FIG. 6. The Presidents table has a plurality of rows, each with a respective globally unique identifier (collectively identified with column label key 205), and other column data, such as an identifier 207 that is locally unique to that table, data elements, and identifiers of files associated with that row, such as identifiers 209 for headshots of each of the presidents having entries in Presidents table 203. Again, a UI is an example source of such data, and automated or programmatically controlled generation or updating is another example implementation; multiple sources of data can be provided.

Returning to FIG. 5A, at 139, input is received through the UI, and at 141, the received input is categorized. In one example, the input is categorized as one of a row insert, a row delete, and a row modify operation. Turning first to an example of row insert, FIG. 5A depicts that the process includes, at 143, accepting a table entry for “Barack Obama” and then updating the Presidents table by inserting a row that will contain values for each of the columns of data in the Presidents table, pertinent to Barack Obama. At 143, a globally unique identifier for the new “Barack Obama” row is generated or assigned (e.g., by obtaining a current value of a counter). At 147, the row insert is logged in update log table 213, which is depicted in FIG. 7. The entry in update log table 213 generated responsive to the row insert includes the generated unique identifier 208 (in a column 215 provided for that data item), a table identifier 217 populated with the name of the table from which the update came (here, table 203), and a version of the table when the row insert was effected (here, version 624). A current version 219 of the table in which the row exists can also be stored. Storing the current version 219 involves determining the highest version number among the insert version 221, update version 223 and delete version 225. Storing the current version number 219 is an optimization but is not required to be implemented.

At 145, a data version table 230 (depicted in FIG. 8) is updated to maintain the current version of presidents table 203, now at version 624. Data version table 230 also depicts an entry 232 for a storage files table 250, which will be discussed below, and which is currently at version 425.

The unique identifier for each row can be implemented as a number incremented with each inserted row. Additionally, each table version can be tracked with an incrementing number. Incrementing is an example, and for the purposes of this disclosure, includes any series of numbers and/or other symbols from which an order can be determined (either by convention or by definition). For example, an alphanumeric identifier can be employed; for the purposes here, incrementing also includes starting from a given portion of a sequence and proceeding in either direction (i.e., either decrementing or incrementing), and incrementing is used in these examples for clarity of disclosure and not limitation of implementation. Timestamps also can be used in generating at least a portion of a unique identifier. Timestamp information can be gathered both on a device being updated and on a backend (e.g., the same information can be updated both in the application being updated and on the server, and timestamps can be used to determine which was the latest update, or to otherwise maintain consistency and durability of the data). The unique identifier also can be implemented as a combination of table name and a row identifier unique within that table (numbers can be used instead of alphanumeric table names or row identifiers). These examples show that a machine representation of the names here may be different from the representation used in this disclosure for the purpose of clarity. Here, the identifier is to be unique among the tables or other dataset to be synchronized, for a particular application. It is possible, for example, to have a different identifier for the same row (or object) for different applications. It also is possible to use the same identifier to refer to different rows in different applications.

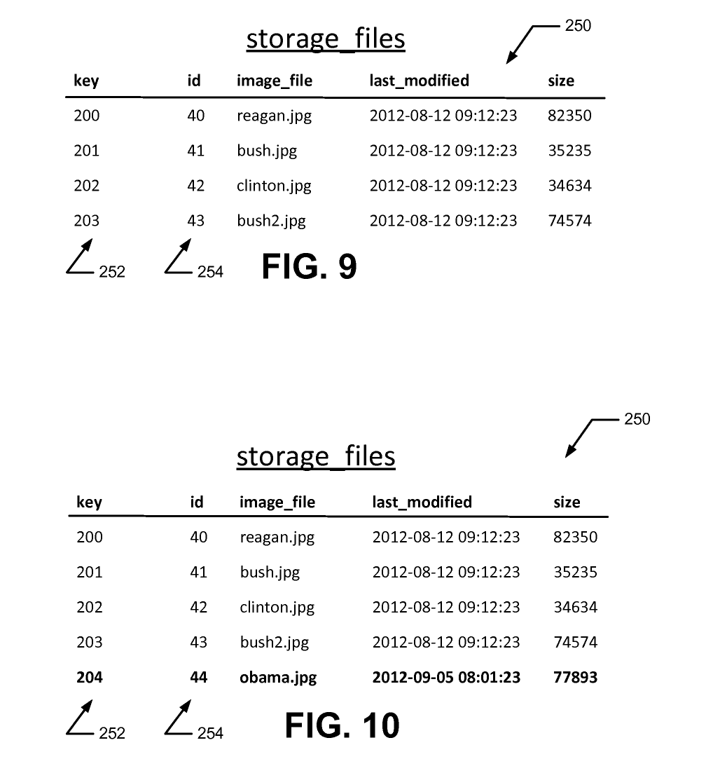

Returning to FIG. 5A, at 151, a new row is added to the storage files table, and in accordance with the disclosure, is assigned a unique identifier. This aspect of updating/adding/deleting resource files, and coordinating content is described with respect to FIG. 9 and FIG. 10. FIG. 9 depicts a storage files table 250 having keys 252, and identifiers 254, along with other information pertaining to each resource listed in storage files table 250. For example, in FIG. 9, the headshot for George HW Bush (“bush2.jpg”) has key 203, and identifier 43, along with a file name, last modified info and size info.

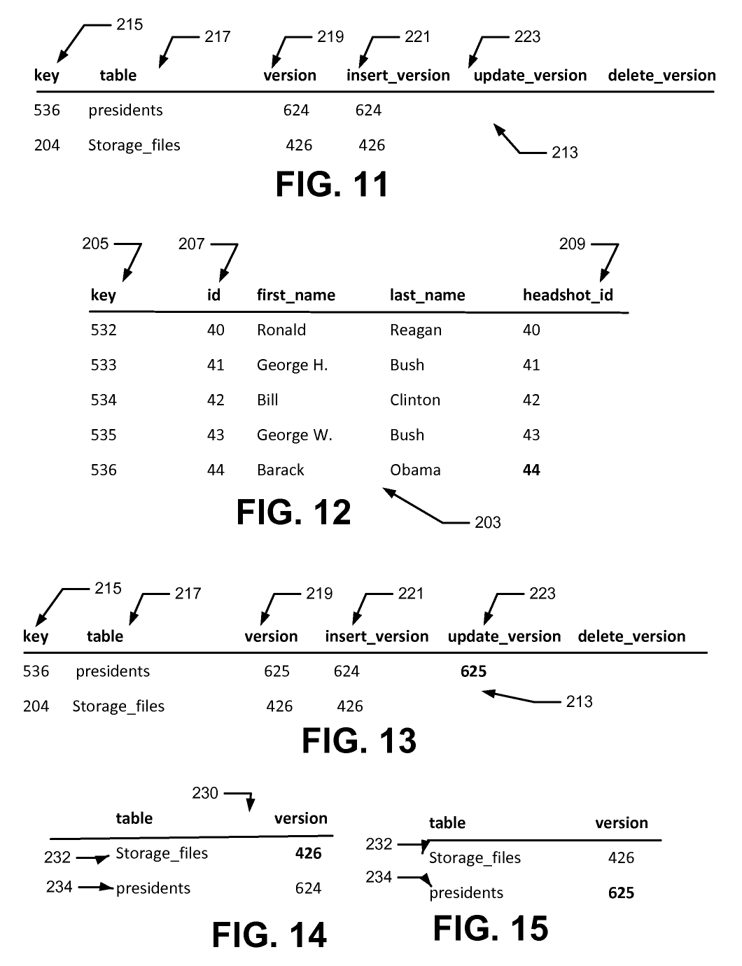

The insertion described above (151 of FIG. 5A) is shown in FIG. 10, where storage files table 250 is shown to have an added key 204 to the keys 252, in the row for the obama.jpg file. The obama.jpg file is given ID 44 (in identifiers 254). At 153, the row insert of 151 is logged in the update log table 213. FIG. 11 depicts update log 213 now containing a row for key 204, which was the key for the new row added to storage files table 250. In FIG. 11, update log table 213 shows that the key 204 and associated data was added to storage files table 250 and caused the version of this table to increment from version 425 (See FIG. 8) to 426, and version 219 and insert version 221 columns include this version identifier. At 155, data version table 230 is updated to reflect a new version of storage files table 250 (this table update is not separately depicted, but is in accordance with FIG. 8 and with FIGS. 14 and 15 described below).

At FIG. 5B, an example of how a row modify operation is processed is shown and described. At 175, presidents table 203 is updated with a reference to the image added (“obama.jpg”), as shown in FIG. 12. Here, key 536 is for Barack Obama, and so the headshot_id column is populated with the ID from storage files table 250 corresponding to “obama.jpg”, which is ID 44. At 177, the update to the row for Barack Obama is logged in the update log table 213 with an incremented version number. In particular, because presidents table 203 again was changed, FIG. 13 depicts update log table 213 with key 536 (corresponding to presidents table 203), having an update version column 223 value populated with 625 and a version column 219 also populated with that incremented version number (625). Thus, presidents table 203 was updated to include Obama at version 624, and obama.jpg was associated with the Obama row in version 625 of presidents table 203.

At 179, data version table 230 is updated to include the current version number of presidents table 203, being 625. FIGS. 14 and 15 depict this update by depicting data version table 230 being updated to reflect that the latest version of presidents table 203 is version 625 (entry 234 in data version table 230). Entry 232 is for the storage files table 250, which was not updated when presidents table 203 was updated, so that its version number remains the same.

FIG. 5C depicts a set of actions that are taken in response to a row delete operation. These operations generally correspond to those of the row modify operation depicted in FIG. 5B, except that the change is to delete a row. Here, deleting a row can be effected by adding a current version number of the table in which the deleted row exists to that row's deleted version column 225 (see FIG. 7). The example depicted thus includes, at 183, that an existing row of presidents table 203 is indicated as deleted (by an input) and at 185, that update log table 213 is updated, and at 187, data version table 230 is updated. At 189, the delete is completed. Thus, deletion does not require that the information is entirely removed from the table, but simply that it be indicated as deleted. The update in the mobile device can be effected by indicating that the row is deleted, or by actually deleting the data from the local store.

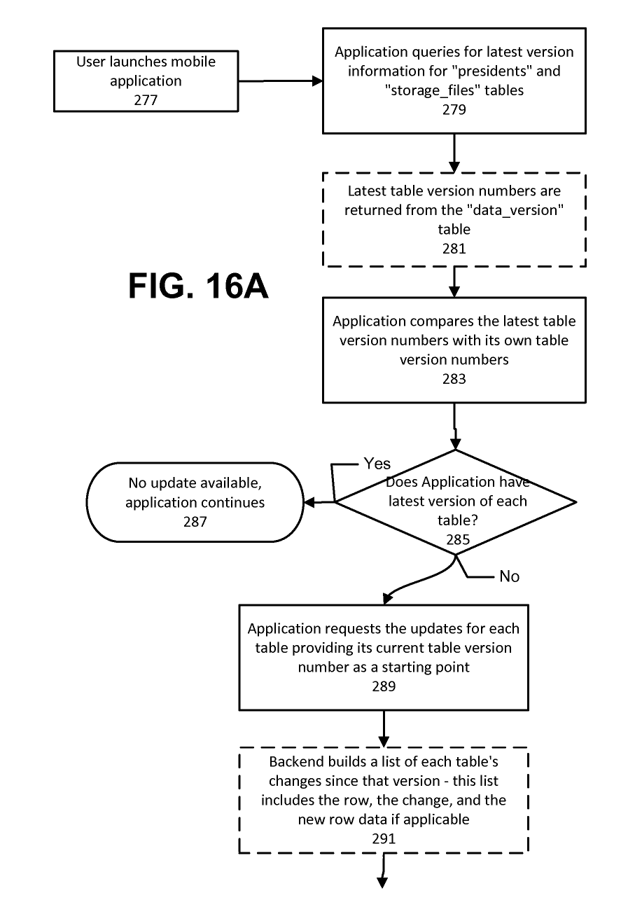

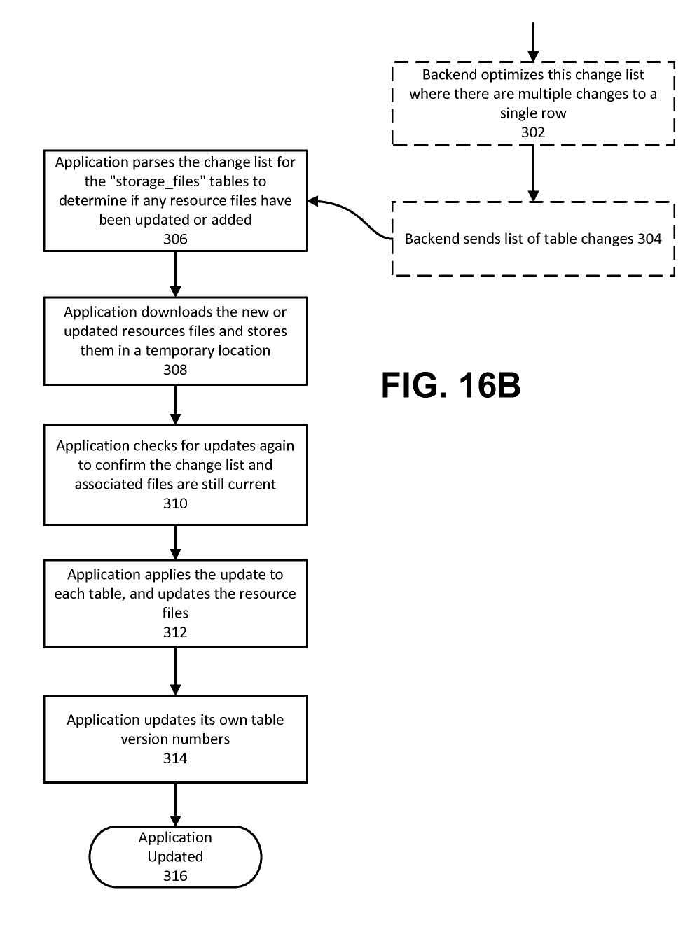

FIG. 16A depicts a process by which local device data is updated, using tables and other data described above. At 277, a user can launch or otherwise activate the application that will be updated; other trigger mechanisms can include an application returning to foreground status, a push notification of an available update, a manual refresh, a change in physical position of the device or some other situation or indication that would trigger a potential for receiving updated data. The application queries for the latest version information for all tables that are indicated as being synchronized. These tables can refer both to data tables and tables that refer to resource files. In the example above, presidents table 203 and storage files table 250 are synchronized data. Storage files table 250 refers to resources (e.g., files) that are synchronized because they are referenced in storage files table 250. These latest table numbers are returned to the mobile device from a lookup in data version table 230, which tracks the latest versions of the synchronized tables. At 283, the application compares these version numbers returned to the mobile device with its own version numbers, and at 285, the application determines whether it has the latest version of each table by comparing the version numbers. At 287, if all versions are equal for all tables, then no update is available. Otherwise, at 289, the application requests updates for each table and provides its current version number for each table in such request. At 291, the backend (e.g., sync interface module 43) identifies all changes to each table, between the version provided by the application and the current version. This operation can be performed using update log table 213. This operation can include, for each table being synchronized, identifying all rows in update log table 213 that have version numbers newer in one or more of their insertion, modification, and deletion columns.

Continuing at FIG. 16B, at 302, the backend can optimize (optionally) the set of changes that are returned to update the local data storage, and sends the final set of changes to be made to each table identified as needing synchronization. An example of optimization is to remove from the set of returned changes any changes that do not affect the final set of local data on the devices. One approach to implementing such optimization is to use update log table 213 and the versions stored for any row, including for inserting 221, updating 223 and deleting 225. As an example, a row may have been inserted in a table when that table was at version 10, updated last at version 100, and then deleted at version 120. Even if a mobile device had local data synchronized only to version 5, the returned changes can exclude the insert and update operations, because of the subsequent delete operation. For any combination of version numbers associated with an insert, update or delete change recorded for a given row, it can be determined whether an update is necessary or not and what the content of that update is, to make the local data of that row current. Multiple updates to the same data can be represented by the last-in-time update to that data, an insertion followed by an update does not need to be included, insertions or updates followed by a deletion do not need to be included. In conclusion, an update package can be formed to contain only data that affects a final state of the synchronized dataset, and not intermediate changes.

At 304, the list of changes for the synchronized tables is sent to the mobile device; and at 306, the list of changes is parsed to determine what files or tables should be updated. In the particular case of a table that refers to resource files (e.g., storage files table 250), at 308, any new or updated resource file is downloaded and stored. The storage can be in a temporary location, allowing a selection of time as to when the update will be applied and to apply the entirety of the update consistently. Data for tables that are being synchronized can be sent in a JavaScript Object Notation (JSON) format. In an example, a JSON package can have a list of tables to be updated, identifiers for the version that the changes are current to, and changes to be made to each row to bring each table to the specified version.

At 310, a further check for updates occurs, which confirms that the change list received and the files that are used or otherwise referenced by those changes have been received (e.g., if a reference to obama.jpg was added to presidents table 203 before obama.jpg was added to storage files table 250, updating only presidents table 203 would not result in a fully functioning application. More generally, it is not required that an application data store be updated to the latest version available on a central data store, but rather that the application data store be updated to a state that is self-consistent and capable of being represented at the central data store. Thus, partial updates may be performed, in which only certain resources are brought to a current version. These resources may be ones that are predicted as being most likely to be used sooner than other resources that require updating. In some cases, table data (e.g., the object data) may be updated before larger files or other resources referenced by that table data are updated or downloaded. For example, catalog data may be downloaded to allow searching for new items, before pictures of those items are downloaded. An update containing the catalog data only may be downloaded, before an update containing the pictures is begun.

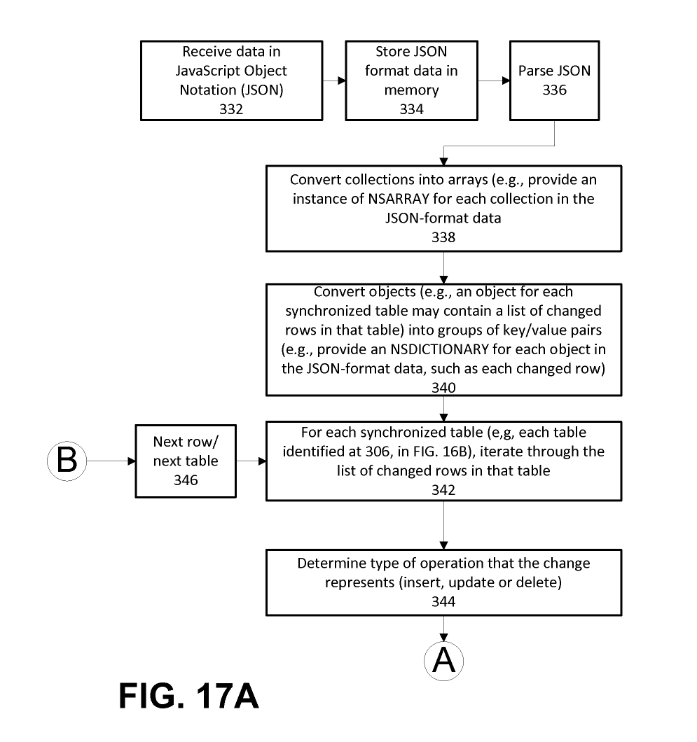

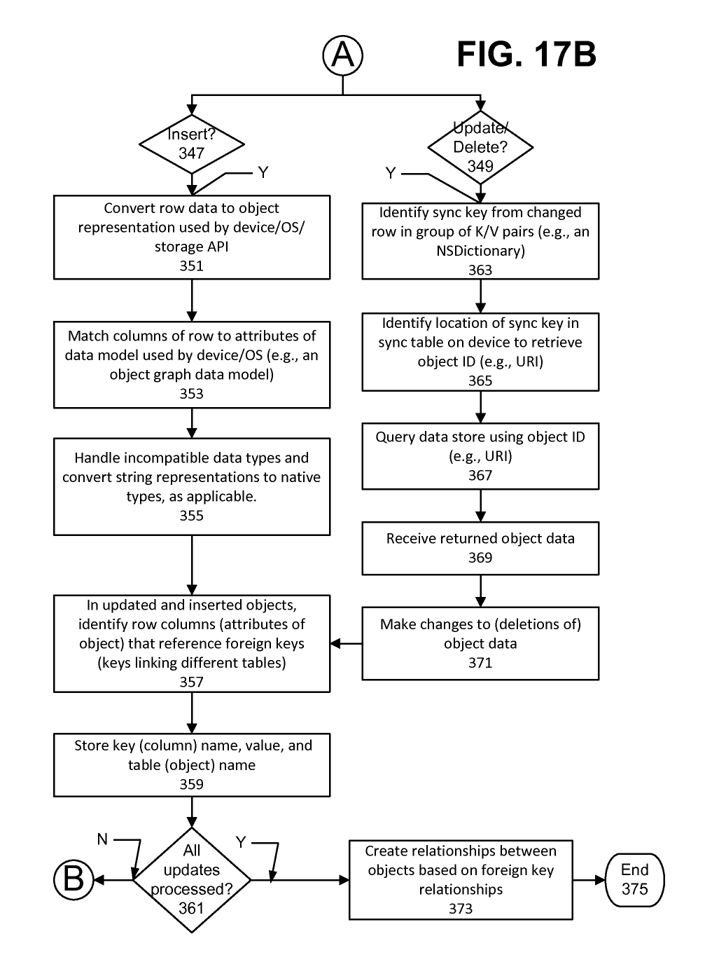

At 312, the application applies the changes from the list of changes to its local data. The changes can be applied according to the data model or API being used on that mobile device platform. For example, some local devices may use an SQL API in order to effect changes to local data, and thus can make these changes through the API. FIGS. 17A and 17B depict aspects of a more specific example of how an application or update service can update a data repository on a device. At 314, the application updates its table or tables that track the version numbers of the resource and data tables in local storage. For example, the application can maintain a local version of data version table 230 that tracks the highest version of the table synchronized.

FIGS. 17A and 17B depict aspects of a process that can be implemented on a device receiving synchronization information. In one example, JavaScript Object Notation (JSON) is used to transmit update data (e.g., a list of tables changes as in 304 FIG. 16B). At 332, data in JSON format can be received by a device (e.g., an application resident on a device) and, at 334, that JSON-formatted data can be stored. At 336, the JSON data can be parsed. The JSON data can include collections of elements, which, at 338, are converted into arrays. For example, where a CoreData object model, or a similar graph model, is used, an instance of an array (e.g., an NSARRAY) can be provided for each collection in the JSON-formatted data. At 340, objects are converted into groups of key/value pairs. In one example, an object may contain one or more rows for a table that are to be updated (i.e., a table as represented on the server side, even though the data model may be different in the operating system or device being updated). In a Core Data object model, each row to be updated can be represented by an NSDICTIONARY.

At 342, for each synchronized table, the changed rows of that table are iterated. This can be represented by cycling through each NSDICTIONARY. At 344, a type of update to be implemented to effect the change represented by the NSDICTIONARY is determined (e.g., insert, delete or update). At 347, if the operation is insert, then, at 351, the row data is converted into an object representation appropriate for the device, OS or storage API on which the update application is dependent. At 353, each column of each row is matched to an attribute of the data model on the device. At 355, data types that are incompatible or those that have special formats or meanings within a device object model or data representation can be mapped. For example, although JSON may represent a date as a string, the device object model may have a specific type for dates, and these strings are to be converted to that type.

If the update was not an insert, but rather a delete or update, then at 349, this is determined and at 363, a synchronization key is identified within data for that row (i.e., the entry for which these operations are being conducted). That synchronization key is used to identify a location of the synchronization key in data (e.g., a table) maintained on the device (as an example location of such table). For example, mapping 54 in FIG. 3A may contain mappings between object Uniform Resource Identifiers (URIs) and unique identifiers. From that mapping, an object URI can be retrieved. The synchronization table provides a layer of abstraction from the updater function, and the native object model, such that updates can be made transparently to a user and to other functions on the device.

At 367, data associated with that object URI is retrieved, such as by using an API call that accepts the object URI as an argument. At 369, that object data is received, and at 371, changes to or deletions of that data can be effected. Where there is a deletion of data, some implementations may not need to parse such data, if the API provides a delete function that accepts an object URI.

At 357, for inserts and updates, row columns that reference foreign keys (fields or columns in one table or collection that match to a key in a different table or collection) are identified. At 359, these keys and associated information are stored. At 361, a determination whether all updates have been processed can be made (e.g., that there are no further NSDICTIONARIES to process). If the result is negative, then the process can return as shown to 346, where a next row or next table can begin to be processed. Otherwise, relationships between objects based on the identified foreign keys are established using the data stored at 359. Thus, there is a deferred creation of relationships between objects, which allows all objects to be created or updated, before relationships among objects are attempted to be created. At 375, the process can complete. In one example, this update process can be used to update data stored as a graph of objects, each of which may have one or more attributes. For example, Core Data can be updated according to this process, and using the disclosed structures and related information.

The term “table” was used in the disclosure to refer to the database concept of having a multilevel hierarchy of data organization (where a database has a set of tables, and each table has a set of rows, and each row has a set of values for a defined set of fields.) However, usage of such terminology is not by way of limitation as to how such data is actually stored or represented, but rather refers to the logical organization of such data, and how it is manipulated, maintained and other operations that are performed in furtherance of the synchronization processes disclosed. Thus, referring to these concepts using terms found primarily in the context of relational databases is not by way of exclusion of other data representations

In some aspects, implementations of these synchronization techniques can be used in conjunction with data caching techniques, where a certain set of data can be indicated as being synchronized (and hence, a version of such data will be locally available and synchronized as the opportunity presents itself). Other data may be available when there is an active network connection and may be cached temporarily. Data that is cached can be determined according to a heuristic. Update packages also can be produced and offered (or to begin) downloading preemptively, during real-time usage of an application. Such update packages can have content selected according to a heuristic. Heuristic(s) employed for these purposes may take into account a number of different status indicators and other contextual information.

For example, a heuristic can take into account characteristics or usage models of data in different kinds of applications, and prepare update packages or cache data for a specific application or type of application different from another type of application. For example, a download heuristic for a mapping application may take into account a current speed of movement of the mobile device, as well as direction information. That heuristic may then be used to select a subset of data from a table relating to points of interest that will be within a given distance at some future time. An application involving a catalog application may gather past usage history by a particular user. This usage history may be reflected in requests for data being served by a remote data store. Such application usage and data request history may inform a heuristic for predictive update packages for that application. For example, each salesperson for a given company may have a certain usage pattern of an application for that company's catalog, and update packages may be formed predictively based on prior usage patterns, and also on a current location or usage of the application. A further example is a video streaming application. A predictive update heuristic for such an application may include categories of videos that a user of the application has previously viewed; the first portion of videos that are trending within that category may be predictively downloaded. Update heuristics also can take into account availability of low cost or free connections, versus connections that charge (or charge more) for traffic.

Also, it was discussed that which data is synchronized may be determined or selected from a larger set of data. Data that is to be cached and/or synchronized can be determined according to analytics that infer a usage model for such data, and can be based on prior usage of data by a particular user, or by other users, which may be determined to have one or more characteristics in common with the user whose device is being synchronized. An Application Programming Interface (API) in the present context includes an interface exposed by an application or a datastore, and also includes other interfaces for allowing programs to communicate with each other or allowing a program to communicate with a datastore, in a published format, and can include interfaces for web services.

An update package as a whole can be cached. The update package can be associated with metadata that tracks how the update package updates a particular set of data. For example, a range of identifiers and a version for that identifier can be associated with the update package. Update packages can be compressed before transmission and decompressed by a client-side update process.

On a network transmission control layer, data being updated for a synchronization process or in response to a user request can be prioritized or otherwise capacity controlled. In one example two or more Real Time Protocol (RTP) streams can be implemented, each being managed by a different thread of processing. Start, throttle, unthrottle, and reordering of downloaded data can be implemented on one or more of the streams. In one example, one stream can be a priority stream, and the other can be operated on an opportunistic basis. In one example, content delivery can be staged based on a present status of where a user is in the application. For example, content can be put on a priority channel if it is expected to be needed sooner than other content.

The order of activities depicted in the diagrams is not by way of limitation that such activities must be, or are preferred to be performed in that order. Additionally, there may be situations where not all depicted activities are performed for a given synchronization operation. For example, some data or table organization or formatting may already have been performed, and so, such activities would not need to be performed again.

As would be apparent from the disclosure, some of the components and functionality disclosed may be implemented in hardware, software, firmware, or any combination thereof. If implemented in firmware and/or software, the functions may be stored as one or more instructions or code on a computer-readable medium, in one example, the media is non-transitory. Examples include a computer-readable medium encoded with a data structure and a computer-readable medium encoded with a computer program. Machine-readable media includes non-transitory machine readable media. Other kinds of media include transmission media. A non-transitory medium may be any tangible medium that can be accessed by a machine. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a machine.

Those of skill will also appreciate that the various illustrative logical blocks, modules, circuits, and algorithm steps described in connection with the embodiments disclosed herein may be implemented as electronic hardware, computer software in a computer-readable medium, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Modern general purpose processors regularly require in excess of two billion transistors to be implemented, while specialized processing units, such as graphics processing units, may have in excess of five billion transistors. Such transistor counts are likely to increase. Such processors have used these transistors to implement increasing complex operation reordering, prediction, more parallelism, larger memories (including more and bigger caches) and so on. As such, it becomes necessary to be able to describe or discuss technical subject matter concerning such processors, whether general purpose or application specific, at a level of detail appropriate to the technology being addressed. In general, a hierarchy of concepts is applied to allow those of ordinary skill to focus on details of the matter being addressed. This applies equally to services supplied using such processors by machine executable code executing thereon.

When addressing some particular feature of an application or process, it may be appropriate to identify substituent functional components, and abstract some of these functional components, while providing more detail as to other components. In other circumstances, a particular combination of functions itself describes patentable innovation, aside from the particular examples of structures in a specification that may be used in describing such combination.

When a processor or processors is configured by machine readable code to perform a function or set of functions, that processor or processors, or portion(s) thereof effectively become circuitry for performing that function or set of functions. Such circuitry may interface with other structural elements, such as memories, user interface components, network interfaces, and so on. Configuration of such processor(s) also changes as different parts of machine code are used to configure the same or different constituent elements of such processor(s). As such, although it would be possible to describe a circuit resulting from configuring a processor to perform a series of instructions, such explanation would be unhelpful to a person of ordinary skill in the art, who would rather be taught more specifically about the technology contributed by Applicant's disclosure.

As such, the term “circuitry” does not imply a single electrically connected set of circuits. Circuitry may be fixed function, configurable, or programmable. In general, circuitry implementing a functional unit is more likely to be configurable, or may be more configurable, than circuitry implementing a specific portion of a functional unit. For example, an Arithmetic Logic Unit (ALU) of a processor may reuse the same portion of circuitry differently when performing different arithmetic or logic operations. As such, that portion of circuitry is effectively circuitry or part of circuitry for each different operation, when configured to perform or otherwise interconnected to perform each different operation. Such configuration may come from or be based on instructions, or microcode, for example.

In all these cases, describing portions of a processor in terms of its functionality conveys structure to a person of ordinary skill in the art. In the context of this disclosure, the term “unit” refers, in some implementations, to a class or group of circuitry that implements the functions or functions attributed to that unit. Such circuitry may implement additional functions, and so identification of circuitry performing one function does not mean that the same circuitry, or a portion thereof, cannot also perform other functions. In some circumstances, the functional unit may be identified, and then functional description of circuitry that performs a certain feature differently, or implements a new feature may be described.

For example, a change monitor operable to detect an update to any of the plurality of tables and to log the update can be implemented by code executing on one or more general purpose processes that interface to one or more memories, which can be arranged in a hierarchy. Such updates may come from another device, such as through a network interface. An update parser to maintain a table describing all updates made to the plurality of tables, where each update in the table of updates has an individual and unique identifier also can be implemented by a processor configured with machine executable code for performing this function. An update packager to produce an update package in response to a request from a mobile device specifying a set of the tables, or a portion of one or more of the tables, to be synchronized also can be implemented by a processor configured with machine executable code for performing this function. These functional elements may use supporting database hardware and/or software executing on such hardware, or other services supplied by computing infrastructure. An update applicator on the mobile device that uses a native application data storage model to apply the updates identified in the update package to local data stored on the mobile device also can be implemented by a processor configured with machine executable code for performing this function. Such update application may use a framework or a part of a framework for applications executing on the mobile device, to access local data on the device. There is no requirement that the same processor or processors be used to implement each functional element described above, and instead various processors can be configured to cooperate to perform one function or multiple of these functions.

Although circuitry or functional units described herein may be most frequently implemented by electrical circuitry, and more particularly, by circuitry that primarily relies on a transistor implemented in a semiconductor as a primary switch element, this term is to be understood in relation to the technology being disclosed. For example, different physical processes may be used in circuitry implementing aspects of the disclosure, such as optical, nanotubes, micro-electrical mechanical elements, quantum switches or memory storage, magnetoresistive logic elements, and so on. Although a choice of technology used to construct circuitry or functional units according to the technology may change over time, this choice is an implementation decision to be made in accordance with the then-current state of technology. This is exemplified by the transitions from using vacuum tubes as switching elements to using circuits with discrete transistors, to using integrated circuits, and advances in memory technologies, in that while there were many inventions in each of these areas, these inventions did not necessarily fundamentally change how computers fundamentally worked. For example, the use of stored programs having a sequence of instructions selected from an instruction set architecture was an important change from a computer that required physical rewiring to change the program, but subsequently, many advances were made to various functional units within such a stored-program computer.

Functional modules may be composed of circuitry, where such circuitry may be fixed function, configurable under program control or under other configuration information, or some combination thereof. Functional modules themselves thus may be described by the functions that they perform, to helpfully abstract how some of the constituent portions of such functions may be implemented.

In some situations, circuitry and functional modules may be described partially in functional terms, and partially in structural terms. In some situations, the structural portion of such a description may be described in terms of a configuration applied to circuitry or to functional modules, or both.

Although some subject matter may have been described in language specific to examples of structural features and/or method steps, it is to be understood that the subject matter defined in the appended claims is not necessarily limited to these described features or acts. For example, a given structural feature may be subsumed within another structural element, or such feature may be split among or distributed to distinct components. Similarly, an example portion of a process may be achieved as a by-product or concurrently with performance of another act or process, or may be performed as multiple separate acts in some implementations. As such, implementations according to this disclosure are not limited to those that have a 1:1 correspondence to the examples depicted and/or described.

Above, various examples of computing hardware and/or software programming were explained, as well as examples how such hardware/software can intercommunicate. These examples of hardware or hardware configured with software and such communications interfaces provide means for accomplishing the functions attributed to each of them. For example, a means for performing implementations of software processes described herein includes machine executable code used to configure a machine to perform such process. Some aspects of the disclosure pertain to processes carried out by limited configurability or fixed function circuits and in such situations, means for performing such processes include one or more of special purpose and limited-programmability hardware. Such hardware can be controlled or invoked by software executing on a general purpose computer.

Implementations of the disclosure may be provided for use in embedded systems, such as televisions, appliances, vehicles, or personal computers, desktop computers, laptop computers, message processors, hand-held devices, multi-processor systems, microprocessor-based or programmable consumer electronics, game consoles, network PCs, minicomputers, mainframe computers, mobile telephones, PDAs, tablets and the like.

Also, in some cases, terminology has been used herein because it is considered to more reasonably convey salient points to a person of ordinary skill, but such terminology should not be considered to impliedly limit a range of implementations encompassed by disclosed examples and other aspects. A number of examples have been illustrated and described in the preceding disclosure. By necessity, not every example can illustrate every aspect, and the examples do not illustrate exclusive compositions of such aspects. Instead, aspects illustrated and described with respect to one figure or example can be used or combined with aspects illustrated and described with respect to other figures. As such, a person of ordinary skill would understand from these disclosures that the above disclosure is not limiting as to constituency of embodiments according to the claims, and rather the scope of the claims define the breadth and scope of inventive embodiments herein. The summary and abstract sections may set forth one or more but not all exemplary embodiments and aspects of the invention within the scope of the claims

The description of the aspects and features is provided to enable any person skilled in the art to make and use the systems, apparatuses and perform the methods disclosed. Various modifications will be readily apparent to those skilled in the art, and the principles described in this document may be applied to other aspects without departing from the spirit or scope of the disclosure. Thus, the description is not intended to limit the claims. Rather, the claims are to be accorded a scope consistent with the principles and novel features disclosed herein.

The drawings include relative arrangements of structure and ordering of process components, solely as an aid in understanding the description. These relative arrangements and numbering is not an implicit disclosure of any specific limitation on ordering or arrangement of elements and steps in the claims. A sequence of elements of a process can be interchanged without departing from the scope of the disclosure, and means-plus-function clauses in the claims are intended to cover the structures described as performing the recited function that include not only structural equivalents, but also equivalent structures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than, additional to, or less than, those identified herein. Rather, the described features and steps are disclosed as examples of components of systems and methods within the scope of the appended claims.

We claim:

1. A method for use in remote device data synchronization, comprising:
storing a set of data tables in a non-transitory machine readable medium, each table having a set of rows, and each row having a set of columns and a row identifier that is unique among all rows of all of the tables in the set of the data tables, wherein each data table of the set is associated with a respective current table version;
identifying a row insert operation to any data table of the set, and responsively producing a unique row identifier for that row,
creating an entry in a change log table, the created entry having the produced unique row identifier, and the then-current version of the data table as an insert version identifier, and
updating the current table version for that data table;
identifying a row update operation to any data table of the set, and responsively locating the unique row identifier for that row in the change log table, and
associating the then-current version of the data table as an update version identifier, and
updating the current table version for that data table; and
identifying a row delete operation to any data table of the set, and responsively locating the unique row identifier for that row in the change log table,
associating the then-current version of the data table as a delete version identifier, and
updating the current table version for that data table.

2. The method for use in remote device data synchronization of claim 1, further comprising receiving a request for synchronization that identifies one or more tables of the set of tables, responsively identifying a current version of each of the one or more tables identified in the request, and returning those identified current versions to a device that generated the request.

3. The method for use in remote device data synchronization of claim 2, further comprising receiving identifiers for versions of each of the one or more tables that are present on the device that generated the request, and identifying a set of updates for each of the one or more tables by comparing the received identifiers with contents of the change log table.

4. The method for use in remote device data synchronization of claim 1, further comprising receiving a request for synchronization that identifies a portion of a table of the set of tables, responsively identifying a current version of the identified table, and returning an update package comprising any updates contained in the identified portion of the table.

5. The method for use in remote device data synchronization of claim 1, further comprising maintaining a version table having an entry for each table of the set of tables, the version table containing the respective current table version for each table of the set of tables.

6. The method for use in remote device data synchronization of claim 1, wherein the change log table further comprises a table name for each entry in the change log table.

7. The method for use in remote device data synchronization of claim 1, wherein the unique row identifier comprises a number and a table name for each entry in the change log table, and the number is unique among all of the rows in that table.

8. The method for use in remote device data synchronization of claim 1, wherein the producing of the unique row identifier comprising obtaining a current value of a counter incremented each time a row is added to any table of the set of tables.

9. The method for use in remote device data synchronization of claim 1, wherein the data tables are stored as respective collections of elements, each element corresponding to a row.

10. (canceled)

11. A method for synchronizing server data with application data stored on devices, comprising:
detecting a change made to a table in a set of tables stored in a non-transitory machine readable medium, each table having one or more rows of data, each row having a key unique among all rows in the set of tables;
responsive to detecting the change,
updating a respective entry in a data version table for each table affected by the detected change, each entry comprising the respective key from the row of the table affected by that change and a current version of the table where that row exists,
creating a respective entry in a data update table that describes the change, the entry in the data update table comprising the respective key of the row affected by that change, and
responding to a data synchronization request from a network connected device with an application, configured to use a local representation of the set of tables, by performing an update process comprising
extracting a current version identifier in the data synchronization request for each table to be synchronized, each current version identifies indicating a then-current version of a respective table on the network connected device,
identifying all change entries contained in the data update table that have a version subsequent to that of the current version identifier for each table to be synchronized, and
sending the identified change entries for receipt by the network connected device.

12. The method of claim 11, wherein the set of tables is represented as an object graph on the non-transitory medium.

13. The method of claim 11, wherein the set of tables is represented as a respective collection of elements for each table, wherein each element includes data for a respective row of the table to which that collection pertains.

14. The method of claim 11, wherein the identified change entries are sent in JavaScript Object Notation format.

15. The method of claim 11, wherein the update process further comprises identifying superseded changes, among the identified change entries and excluding identified superseded changes from the identified change entries that are sent.

16. The method of claim 11, further comprising tracking updates to resource files by adding entries to a files version table responsive to an update to a resource file, and including the files version table in the set of tables monitored for changes.

17. The method of claim 11, further comprising receiving the sent identified change entries and applying each identified change entry as a database update to the local representation of the table to which that change entry pertains.

18. The method of claim 17, further comprising updating the current version of the local representation of each table after applying each of the identified change entries that pertain to that table.

19. (canceled)

20. (canceled)

21. (canceled)

22. (canceled)

23. (canceled)

24. (canceled)

25. (canceled)

26. A device comprising:
a processor configured by instructions from a non-transitory machine readable medium to perform a data table synchronization process comprising:
maintaining current local version information for each element of a synchronized dataset,
periodically making a synchronization request comprising the current local version information for at least a subset of the elements in the synchronized dataset,
receiving an update package comprising changes to the elements for which respective current local version information was sent and which had remote datastore versions more current than the current local version, and
applying the update package using an Application Programming Interface (API) provided to access data tables on the device.

27. The device of claim 26, wherein the update package is received in a JavaScript Object Notation format, comprising string-based representations of the changes, and the processor is further configured with instructions that process the string-based representations to identify which of the changes are changes to values having special data types, and converting those string-based representations to a format specified by the API for each data type.

28. The device of claim 26, wherein the synchronized dataset on the device includes an object graph representation comprising one or more graphs of objects, and the changes received in the update package comprise changes expressed in a relational database format, with column values for one or more rows of table data in the synchronized dataset and changes to one or more foreign key references, which comprise references between different synchronized tables in the remote datastore, and the processor is configured to make changes to corresponding objects before making additions or changes to the object graph relating to the foreign key references.

29. The device of claim 26, wherein the API comprises a web services interface.

30. (canceled)

31. (canceled)

32. A system for supporting mobile device application maintenance, comprising:
a server comprising:
a processor configured by instructions from a non-transitory machine readable medium to perform a data table maintenance process comprising:
identifying a set of tables stored on a non-transitory machine readable medium which are to be synchronized with a remote datastore,
providing each row of each table with a respective identifier that is unique among all rows of the set of tables, and
maintaining a unified change table for all tables of the set of tables, the unified change table comprising, for each row that has been changed in the set of tables, the unique identifier of that row, and a set of table version information, the set of table version information indicating a then-current version of the table to which the row belongs for every insert, update and delete operation performed for that row, and
a network interface for sending data to and receiving data from a remote server; and
a device comprising:
a processor configured by instructions from a non-transitory machine readable medium to perform a data table synchronization process comprising:
maintaining current local version information for each of a set of synchronized data tables,
periodically making a synchronization request comprising the current local version information for each table of the set of synchronized data tables,
receiving an update package comprising changes to each table of the set of synchronized data tables, between the current local version and current versions of those tables on the server, and
applying the update package using an Application Programming Interface (API) provided to access data tables on the device.

33. (canceled)
